(19) United States
(12) Patent Application Publication
(10) Pub. No.: US 2010/0088475 A1
(43) Pub. Date: Apr. 8, 2010

(54) DATA PROCESSING WITH A PLURALITY OF MEMORY BANKS

(75) Inventors: Carlos Antonio Alba Pinto, Eindhoven (NL); Ramanathan Sethuraman, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/442,594

(22) PCT Filed: Sep. 21, 2007
(86) PCT No.: PCT/IB07/53836

§ 371 Date: Mar. 24, 2009

(30) Foreign Application Priority Data
Sep. 26, 2006 (EP) 06121280.9

(51) Int. Cl. G06F 12/00

(52) U.S. Cl. 711/149; 711/E12.001

(57) ABSTRACT

A data processing circuit comprises an instruction execution circuit (14) and a plurality of memory banks. The instruction execution circuit (14) is capable of processing blocks of data values (e.g. pixel values for a two-dimensional block of pixels) in parallel. The data values are stored (preferably cached) in the memory banks and supplied in parallel. A plurality of translation circuits (22) is coupled between block addressing outputs of the instruction execution circuits and address inputs of the memory banks. The translation circuits provide for the possibilty of addressing more than one block in parallel from different memory banks. The data is routed to the execution circuit from the selected memory banks by routing circuits. In an embodiment each translation circuit is able to address all memory of the banks. In another embodiment the translation circuits support a plurality of ways of distributing a data of a pixel image over the memory banks, using only a few banks for example for data that is accessed in small blocks and more banks for data that accessed with higher parallelism.

### FIELD OF THE INVENTION

The invention relates to a processing circuit and method for processing multi-dimensional arrays of data.

### BACKGROUND OF THE INVENTION

WO 2005/104027 discloses an image processing circuit with a memory that supports parallel access to pixel values for a block of pixel locations. As is well known a video image can be represented using a two-dimensional array of, say, about 1000×500 pixel locations, each with a corresponding pixel value. For processing purposes pixel values from a smaller window, of say 32×32 locations, in such an image are stored in a fast memory. The known processing circuit provides for parallel access to pixels values for pixels in smaller blocks, of say 4×4 pixels within such a window.

To provide this form of parallel access the fast memory comprises a working memory with a plurality of parallel accessible memory banks, organized in sets. Pixel values for successive locations along lines of pixel locations from the window are stored spread across the memory banks, typically at the same address in different banks and wrapping around to successive addresses. Each next line is stored proceeding from the end of the preceding line, optionally with some memory space in between successive lines to prefetch pixel values for an area next to the current window.

A block contains a subset of the pixel locations of the stored window. When a block is addressed in the working memory, the coordinates of the upper left corner of the block are indicated. From this information the processing circuit identifies the banks that contain the pixel values for the pixel locations at the starting points of the lines and their addresses in the banks. The processing circuit routes the pixel values from these banks and succeeding banks to respective inputs of computation circuitry where pixel values from specific locations relative to the coordinates of the block are needed.

Control of this form of access to the working memory requires the coordinates of the upper left corner of the block plus information that describes how the pixel values of the window are stored, in terms of the starting bank where the pixel value for the upper left corner of the window is stored, the address of this pixel value in that bank, the length of the stored lines of the window, the number of banks before the lines wrap around etc.

Typical operations that are performed with the pixel values from a block include block matching, for example as part of motion vector estimation, DCT (Discrete Cosine Transform) computations etc. Some of these operations involve a plurality of blocks, taken from different images. In order to support such plural access, a plurality of working memories of the above-described type may be provided. However, this requires considerable circuit area.

### SUMMARY OF THE INVENTION

Among others, it is an object to provide for processing of multi-dimensional arrays of data wherein less overhead is required when a plurality of different windows has to be accessed. The invention is defined by the independent claims. The dependent claims define advantageous embodiments.

A data processing circuit according to the invention comprises an instruction execution circuit and a plurality of memory banks for executing an instruction that accesses data values for a block of locations, such as pixel values for a block of pixel locations, in parallel. The executed instruction defines indications of a plurality of selections of a plane and of a block of locations in that plane. A plurality of translation circuits is provided to translate the selections into selections of memory banks and addresses in the memory banks concurrently. Thus, an instruction can be executed that addresses a plurality of blocks at the same time.

Advantageously, a routing circuit provides for routing of data values for an addressed block between any block data port of the instruction execution circuit and any of the memory banks or any set of the memory banks. Thus different block data ports that address blocks for different functions in the instruction can share access to all memory banks or sets of memory banks, so that no copying from one bank to another is needed if different block ports of the instruction execution circuit have to address the same window at different times.

In an embodiment, the indications of selections of planes may define a variable number of memory banks in which data values for a block may be located. Thus for example data for one or more first blocks may be located distributed over one set of memory banks and data for one or more second blocks may be located distributed over two sets of memory banks Optionally data for one or more third blocks may be located distributed over four sets of memory banks. The instruction defines which and how many memory banks are used. Dependent on the defined number of banks a greater or lesser number of banks may be used to access data values for a block of locations with the instruction execution circuit. Thus, different forms of parallel access to blocks may be supported intermixed with one another.

In an embodiment, a plane information look-up memory is provided for storing plane information for respective planes concurrently. The plane information is accessed using an identification of the plane provided by the executed instruction. The plane information for each plane comprises information that indicates which of the memory banks are used to store the data values for the plane.

In an embodiment, each of the translation circuits is coupled to a respective set of the memory banks, for controlling addressing of the memory banks in the respective set. A further routing circuit is provided to route the indications of the selections of the blocks of locations to respective ones of the translation circuits under control of the selected plane. Thus no further circuits are needed between the translation circuits and the sets of memory banks.

In a further embodiment, the further routing circuit is configured to route the indication of the selection of the block of locations from at least a single one of the block addressing outputs to more than one of the translation circuits. This supports the use of a variable number of memory banks in which data values for a block may be located.

In an embodiment, the instructions define a size and/or shape of the block of locations that is addressed. Each block may have a shape of N by M locations in a two dimensional array for example, different shapes corresponding to different combinations of integer N, M values. In this case the product of N and M is the size. The translation circuits perform translation dependent on the indicated size and/or shape.

These and other objects and advantages will become apparent from a description of exemplary embodiments using the following figures.

### BRIEF DESCRIPTION OF THE DRAWINGS

FIG. 1 shows a processing circuit;

FIG. 2 shows a vector access unit and a set of memory banks;

FIG. 3 illustrates use of the memory banks;

FIG. 4 shows a set access circuit;

FIG. 5 shows a vector access unit;

FIG. 6 illustrates use of the memory banks; and

FIG. 7 shows a flow chart of memory access.

### DETAILED DESCRIPTION OF EMBODIMENTS

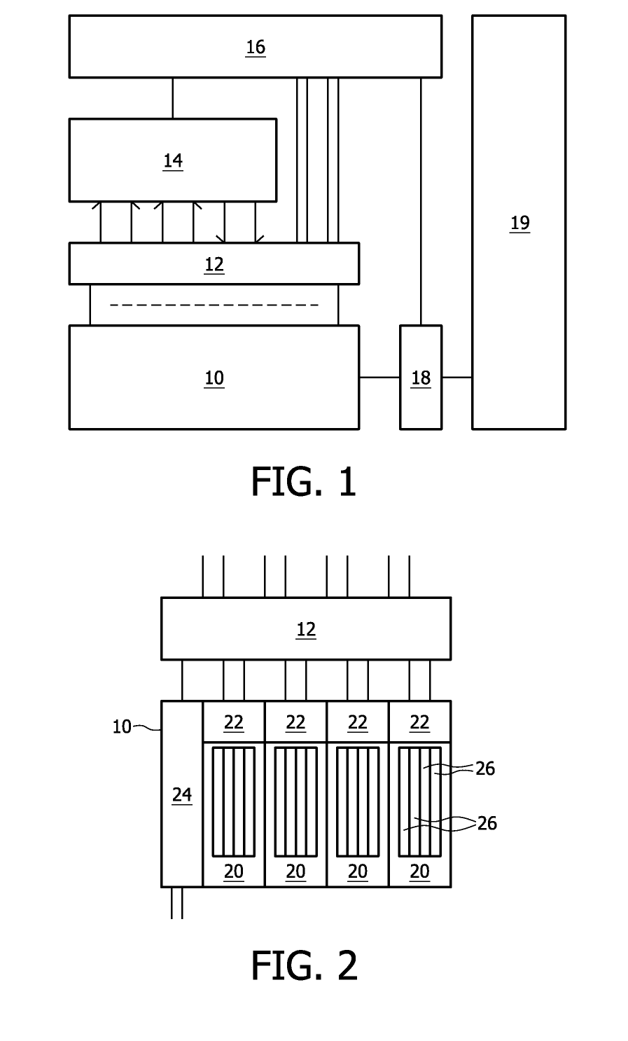

FIG. 1 shows a processing circuit, comprising a banked memory circuit 10, a vector access unit 12, a plurality of functional units 14, an instruction control circuit 16, a memory access unit 18 and a main memory 19. Instruction control circuit 16 has outputs coupled to functional units 14, for selecting operations to be performed, to vector access unit 12, for selecting memory locations of data involved in the operations, and to memory access unit 18, for controlling transfers between main memory and banked memory circuit. Functional units 14 are coupled to a plurality of ports of the vector access unit 12, for receiving operand data involved in the operations and optionally to a port for writing back result data. Vector access unit 12 is coupled to banked memory circuit 10 for accessing the data. Memory access unit 18 is coupled between banked memory circuit 10 and main memory 19. In an embodiment a single functional unit may be used instead of the plurality of functional units.

FIG. 2 shows vector access unit 12 and banked memory circuit 10 in more detail. Banked memory circuit 10 comprises a plurality of sets 20 of memory banks 26, address calculation circuits 22 for respective ones of the sets 20 and a control circuit 24. Four memory banks per set and four sets are shown for the sake of illustration. In practice a different number of sets and/or a different number of memory banks per set may be used.

The banked memory circuit 10 is used to store copies of part of the data values in main memory 19. Data in main memory 19 represents data values for respective locations in an array of locations (typically a two or higher dimensional array). Banked memory circuit 10 stores these data values for a window of locations in such an array, but not for all locations. Banked memory circuit 10 provides for parallel access to data values for selectable blocks of locations within the window. Typically, the size of these blocks is smaller than the size of the window.

During operation the window is moved, so that banked memory circuit 10 progressively stores data values for windows at different positions in the array. In order to minimize the amount of data movement to realize movement of the window, data values for locations that belong to both an old window and a new window remain at the same location in the memory banks. As a result the progressive movement of the window has the effect that the relation between positions in the window and memory locations in the banked memory circuit 10 changes progressively.

Instruction control circuit 16 may comprise a program memory, a sequencer to address successive instructions in the program memory and a register file for storing individual operands. The addressed instructions may be VLIW type instructions, containing operation selection codes and operand and result register address selection codes for a plurality of operations for different functional units. Alternatively single-operation instructions for a single functional unit may be used, with a single operation selection code and operand selection codes and a result register address for the selected operation. In an embodiment, the operand selection codes address registers and outputs of the addressed registers may be coupled to vector access unit 12 to control block selection. Alternatively operand selection codes from the instructions themselves may be coupled to the vector access unit 12, or combinations of codes from the instructions and registers addressed by the instructions may be used.

Although the circuit is applicable to any kind of processing that uses data for two and higher dimensional arrays of locations, the circuit will be described in terms of an image processing operation, involving two-dimensional arrays. This may be applied for example to video image processing, such as video compression or decompression. It should be appreciated that in the figures used for this description many parallel signal conductors are denoted by single lines. Moreover, it should be appreciated that preferably extensive pipelining may be used, i.e. that different successive stages of the described operations may be executed in different execution cycles, while earlier stages of later operations are also in progress. However, pipelining will not be described, as it is not needed for understanding the operations.

In operation, the processing circuit processes instructions of a program, for example a program for processing images. Main memory 19 stores data that represents complete images. An image is defined by a two-dimensional array of pixel locations and pixel values for all of these pixel locations. The program contains an instruction to apply a parallel operation to pixel values for a block of pixel locations. The blocks are much smaller than a complete image, such a for example blocks of 4×4 locations or 8×8 locations. An instruction for performing parallel operations addresses a block and execution of the instruction may involve loading and/or storing the pixel values for the pixel locations in the block in parallel in banked memory circuit 10.

Banked memory circuit 10 provides for parallel access to pixel values for a complete block. In fact, banked memory 10 stores pixel values for a window of pixel locations, the window being larger than a block. Memory access unit 18 controls transfer of the pixel values between main memory 19 and banked memory 10. For this purpose memory access unit 18 may be configured to perform a plurality of different types of commands as part of execution of instructions, including an initialization command, a window move command, a load command and a store command.

The initialization command defines a plane to control circuit 24. The initialization command may have a parameter to define a plane_id, a parameter to select one or more sets of the memory banks wherein the pixel values for the plane will be stored, a parameter to define dimensions of a window of pixel locations for which pixel values will be stored concurrently in the selected set or sets of memory banks, a parameter to define dimensions of prefetch areas of pixel locations adjacent a current window and a parameter to define a starting address in the memory banks where the pixel values for the plane will be stored. Optionally, the initialization command may have a parameter to define subsets within the selected set or sets of memory banks to be used for different lines of pixel locations. Optionally, the dimensions of the window and the prefetch areas may be defined by reference to standard window sizes.

The window move command, when executed, causes control circuit 24 to change the location of a current window in an image. This involves updating plane information that represents a starting address of the window in the memory banks. In addition execution may be used trigger prefetching of pixel values for pixel locations in a next window and/or stalling until pixel values for all pixel locations in the current window have been loaded. The window move command may have parameters to define the plane_id to which the command applies, a scan mode selection parameter and optionally a selection parameter for selecting the sets of memory banks that are involved.

The load and store commands, when executed, cause pixel values for an addressed block of pixel locations to be accessed for a selected plane. These commands may have parameters to select a plane_id and coordinates that address the block involved in the command. Optionally, also the set or sets that are involved are selected. Execution of the load or store command involves accessing the set or sets of memory banks that store the plane, at addresses determined by an address of the selected block, the starting address in the memory banks for the selected plane and the starting address of the current window.

When instruction control circuit 16 processes an instruction to apply an operation to a block of pixels, instruction control circuit 16 applies a command with selection information to vector access unit 12 to indicate a block or a plurality of blocks that is or are selected as operand(s) for the instruction. In response, vector access unit 12 supplies the pixel values for the selected block or blocks in parallel to functional unit 14. Instruction control circuit 16 applies an operation selection code to functional unit 14 to control the operation that is applied to the pixel values.

A typical example of an operation is block comparison, which may be used for motion vector estimation as part of a video compression computation or an intra frame compression operation. Block comparison involves pixel-by-pixel subtraction of pixel values in a pair of selected blocks, possibly from different images. For such an operation the pixel values for corresponding locations in different blocks must be supplied in combination to functional unit 14.

Banked memory 10 provides for storage of pixel values for a plurality of windows together, so that pixel values for blocks of pixel locations from different windows can be accessed intermixed with one another. In a typical example, each window contains pixel values from a different image, or for different color planes from the same or different images, but alternatively different windows may contain pixel values from the same image and/or color plane at different window locations.

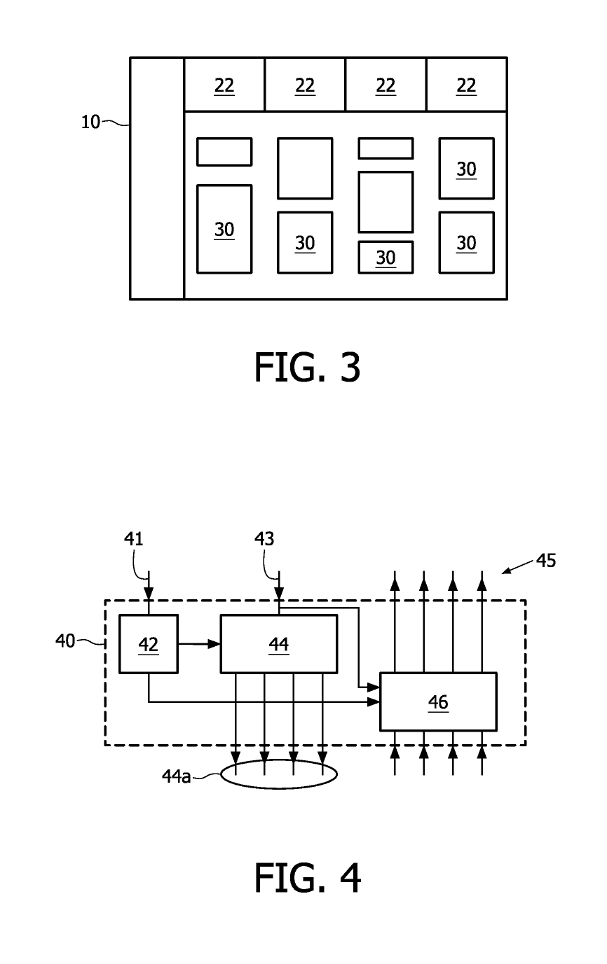

FIG. 3 schematically illustrates an example of a first embodiment of storage of a plurality of windows in banked memory 10. Rectangles 30 symbolize storage of pixel values 30 for respective windows, each spread over successive addresses in a set, the number of addresses being symbolized by the height of the rectangle. When an instruction is to be performed that accesses one or more blocks, instruction control circuit 16 supplies x, y coordinates of the block in the window and a “plane_id” to vector access unit 12. The plane_id identifies the window that is addressed. The plane_id refers to plane information that can be combined with the x,y coordinates, to compute the addresses of the pixels values in the memory banks. The computation depends on the way in which the pixel values for the plane are stored in the memory banks.

The pixel values for a window are stored distributed over the memory banks pixels in a way that is known per se so that pixel values for a segment of pixel locations along a row in the window and for a group of successive rows can be accessed in parallel from different memory banks. That is, the pixel values are stored distributed over the banks so that pixel values that can belong to a same block are not stored at different addresses in the same memory bank. This is known per se.

In an embodiment the distribution involves using a sufficient number of memory banks so that different rows of a block that are less than a block height apart can be stored in different memory banks. Furthermore, in the embodiment it involves using mutually different memory banks for storing pixel values for different pixel locations in a row that are less than a block width apart. In addition, in an embodiment a plurality of pixel values for adjacent pixel locations may optionally be stored together in a memory bank at the same address.

Initially the pixel value for a pixel location at the upper left corner of the window is stored in the first memory bank at the first address of a range of addresses that is reserved to a plane. However, when the window is moved, pixel values for pixel locations in the “new” windows successively replace pixel values for pixel locations in the “old” windows in the memory banks. This has the effect that after a number of moves the first memory bank at the first address of a range of addresses that is reserved to a plane no longer stores the pixel value for the location at the upper left corner of the current window, but instead a pixel value for a pixel location somewhere else inside the window.

In an embodiment the plane information indicates the range of addresses in the memory banks that is used for storing pixel values in the associated window, the coordinates of the stored window and the starting memory bank address where the pixel value at the upper left corner of the window is stored. In a further embodiment wherein different ways of storing windows can be used, the plane information also contains information that indicates the way in which the pixel values are distributed over the memory banks.

FIG. 4 schematically shows a set access circuit 40 for accessing a set of memory banks. When a plurality of sets of memory banks is used, a plurality of set access circuit of this type may be used, at least a respective one for each respective set of memory banks. The set access circuit 40 comprises a plane information look-up memory 42, an address translation circuit 44 and a data crossbar switch 46 that acts as a routing circuit.

Several alternative implementations exist for the plane information look-up memory. In an embodiment plane information look-up memory 42 comprises a plurality of sets of registers, each set for a respective plane_id, different registers controlling different plane properties. As an alternative plane information look-up memory 42 may comprise a memory matrix, with different memory locations that contain data for controlling plane properties. As another alternative general purpose registers in a register file that is addressed by the instructions may be used to store and retrieve plane information. In this alternative retrieval of plane information is performed as a conventional register access.

The circuit has a plane_id selection input 41 coupled to plane information look-up memory 42. Plane information look-up memory 42 has outputs coupled to control inputs of address translation circuit 44 and data crossbar switch 46. Address translation circuit 44 is coupled to an input 43 for receiving block coordinate information. Address translation circuit 44 has address outputs 44a coupled to different memory banks (not shown). Data crossbar switch 46 has inputs coupled to data outputs of the memory banks (not shown) and outputs 45 for supplying pixel values in parallel to the functional unit(s) (not shown). Although an embodiment with only data outputs 45 has been shown by way of example, it should be appreciated that alternatively data inputs or data inputs/outputs may be provided, the circuit being coupled to data inputs or data inputs/outputs of the memory banks.

In operation, instruction control circuit 16 supplies the plane_id and the block coordinates to set access circuit 40. In response set access circuit 40 uses the plane_id to retrieve plane information from plane information look-up memory 42. Address translation circuit 44 uses the retrieved plane information and the block coordinates to compute addresses for accessing the memory banks (not shown). Data crossbar switch 46 uses the retrieved plane information and optionally the block coordinates to control connection between data connections of the memory banks (not shown) and the data connection to the functional unit(s) (not shown).

Plane information look-up memory 42 has memory space for concurrently storing plane information for a plurality of plane_id values, for different windows in the same set of memory banks (for example for different widows 30). Plane information look-up memory 42 supplies plane information for the plane selected by the supplied value of the plane_id.

In a first embodiment set access circuit 40 supports parallel access to pixel values for a segment of pixel locations in only one row of the window at a time from different memory banks, i.e. to N×1 sized blocks, N being the block width. Address computation for this purpose is known per se. As an example for reference, in this embodiment address translation circuit 44 may compute the index of the memory bank that stores the pixel value of the starting point (e.g. the upper left corner) of the block from A0+x/K+w′*y mod L. Herein A0 is the index of the memory bank that stores the first pixel value of the current window (as defined in the plane information) and x and y form the address of the starting point of the block (coordinates of the relative to the start of the window), K is the number of locations stored in each bank, w' is the spacing between the starting banks of successive lines of the window (as defined in the plane information) and L is the number of banks used for the window (as defined in the plane information).

The computed index of the memory bank that stores the pixel value of the starting point is used to control data cross bar switch so as to route the pixel value (or values) from the memory bank with that index to a part of the port 54 where the pixel value for the starting point should be supplied.

In addition address translation circuit 44 may compute the addresses in memory bank where the pixel value in the block are stored. Address translation circuit 44 may compute the address for the starting point for example from BO (the address where the pixel value for the upper left corner of the window is stored, as defined by the plane information) plus the integer part of (x/K+w′*y−A0)/L. Address translation circuit 44 may compute this address plus one pixel values in those banks that have a lower index than the initial bank. The computed addresses are used to address memory locations in the memory banks.

In a second, more complicated embodiment set access circuit 40 may be configured to support access to pixel values for pixel locations in a plurality of segments in a plurality of adjacent rows, from different memory banks i.e. to N×M sized blocks with the block width N and the block height M greater than one pixel location. As will be appreciated this involves a similar address computation by address translation circuit 44 for different lines in the block and distributed storage of pixel values for pixel locations in the same column in different rows over different memory banks.

In a further an embodiment, the size and/or shape of the block is dynamically selectable. Thus for example, N×M blocks may be selected, wherein the integers N and M can take a number of different values for different instructions. N and M may be indicated in the instruction for example, or in the plane information. In one example of this embodiment address translation circuit 44 receives information about the selected N and M values and uses this information to compute the necessary banks.

Instruction control circuit 16 has outputs for selecting a plurality of blocks. A plurality of set access circuits 40 is provided to be able to handle selections from all outputs in parallel. In an embodiment each set access circuit 40 is provided for a respective combination of a set of memory banks and output of instruction control circuit 16. Thus, when the processor executes an instruction with a number of fields for selection operand blocks, each field may be associated with a predetermined set access circuit 40. The field defines the block for example as a literal plane_id and block coordinates in the instruction, or by a selection value that indicates a register that contains the plane_id and block coordinates, or as a combination of literal data and register selection, for example a literal plane_id in the instruction and a selection value in the field that indicates a register that contains the block coordinates.

In this embodiment the plane_id and block coordinates that result from each field of the instruction are supplied to the set access circuit 40 that is associated with the field. The data from the outputs 45 of set access circuit 40 is transferred to the functional unit that executes the operation that is selected in the instructions with the field as operand. When the field is a field for selecting a result of the operation, inputs are used instead of outputs 45 and data is transferred from the functional unit that executes the operation.

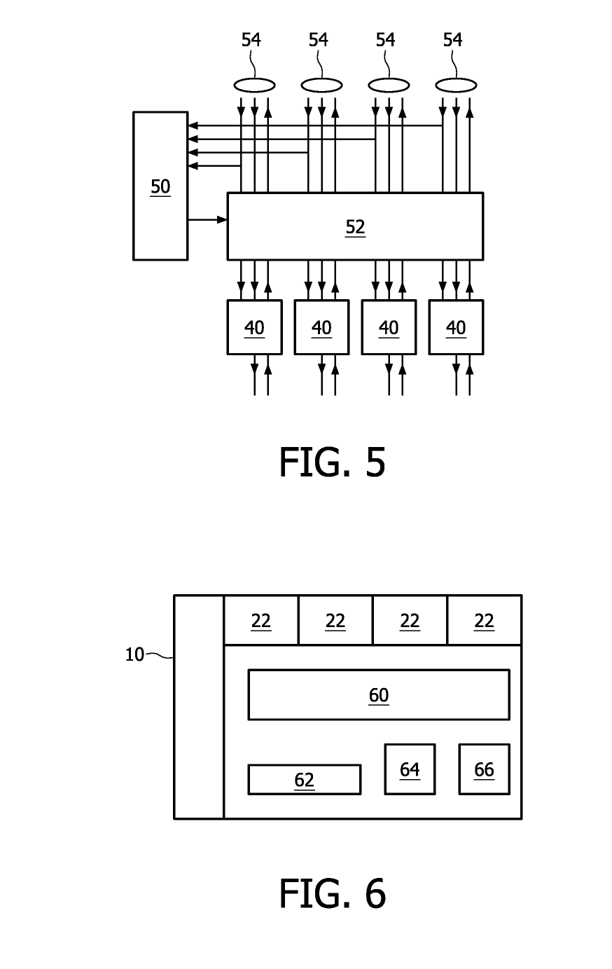

FIG. 5 schematically shows an embodiment of a vector access unit that provides for a more flexible association of instruction fields with sets of memory banks. The vector access unit comprises a plane association circuit 50, an operand cross-bar switch 52 that serves as a further routing circuit and a plurality of set access circuits 40. The unit has a plurality of ports 54 with control inputs that are coupled to instruction control circuit (not shown), which associates each port 54 with a respective predetermined field in an instruction to be executed. Ports 54 also have data outputs and/or inputs coupled to functional units (not shown) that use or produce the data selected by the field. Although four ports 54 have been shown, it should be appreciated that a greater or smaller number may be used.

Operand cross-bar switch 52 is coupled between set access circuits 40 and ports 54 and acts as a routing circuit to route plane and block selections from each port 54 to any of the set access circuits 40, dependent on the plane_id supplied from the ports 54. Plane id connections of ports 54 are coupled to plane association circuit 50, which has an output coupled to an input of operand crossbar switch 52. Plane association circuit 50 may be considered as a shared part of the plane information look-up memory, but is shown separately for the sake of clarity.

Plane association circuit 50 controls cross coupling between set access circuits 40 and a plurality of ports 54, coupling each port to the set access circuit 40 for the set of memory banks that stores the plane identified by the plane_id. In an embodiment plane association circuit 50 stores identifications of the set access circuits 40 associated with each respective plane_id value, retrieves these identifications in response to received plane_id values and makes operand cross-bar switch 52 couple each port 54 to the set access circuit 40 identified by the plane_id input of the port 54. Operand crossbar switch 52 passes the plane_id and the block coordinates from the port 54 to the selected set access circuit 40. Operand crossbar switch 52 passes data back from or to the selected set access circuit 40.

Preferably operand crossbar switch 52 provides selectable routing paths so that any operand selection field of an instruction is routed to any set access circuit 40. Thus each operand selection field can address any set of memory banks Optionally, the data crossbar switches 46 of all set access circuits 40 are also configured to route data between any set of memory banks and any port 54 in correspondence with routing by operand crossbar switch 52. Alternatively, operand crossbar switch 52 may comprise a further data crossbar switch to provide for this degree of routing. As a result, there is no need to store copies of the same pixel values for use by different ports.

Alternatively, operand crossbar switch 52 may provide for limited variable cross coupling, allowing for coupling of ports to overlapping combinations of sets of memory banks without allowing coupling of all ports to all sets. This allows for some degree of sharing of memory banks, without sharing other memory banks between ports (or at least sharing those memory banks between less than all ports). In this way circuit overhead can be reduced if it is known in advance that some sets of memory banks need not be shared.

In principle, the plane information look-up memories may be associated with each port 54, in which case operand cross-bar switch is configured to route the plane information to the relevant set access circuit 40. In another embodiment, only the plane_id is routed, the plane information look-up memories being associated with the set access circuit, where it addressed by the routed plane_id.

Although an embodiment has been shown wherein the set access circuits 40 are associated with sets of memory banks, so that block addresses must be routed to the set access circuits 40 from the ports 54 under control of the plane_id's or plane information, it should be appreciated that alternatively the set access circuits 40 could be associated with ports 54, so that bank addressing will have to be routed. In this embodiment bank selection may be effected before or after routing, i.e. on the side of the memory banks or on the side of the ports 54 relative to operand crossbar switch 52.

FIG. 6 illustrates use of banked memory 10 in an embodiment wherein windows 60, 62, 64, 66 may be stored distributed over an adaptable plurality of sets of memory banks. In the example, pixel values for one window 60 are stored distributed over all sets. Pixel values for another window 62 are stored distributed over two sets. Pixel values for further windows 64, 66 are stored in respective sets. It should be appreciated that the Fig. presents only one example of storage. In practice other combinations of storage of windows may be used. For each plane, a selected combination of sets of memory banks may be used, and a range or ranges of addresses in the memory banks in the selected sets. For example, planes that use one set, planes that use two sets and planes that four sets may be selected. Use of more sets enables greater parallelism for selected sets.

One advantage of this form of storage is that it supports use of differently sized blocks as operands. For example, if storage of pixel values for a window 64 in one set supports parallel access to 4×4 pixel location blocks, storage of pixel values for a window 60 in four sets supports parallel access to 8×8 pixel location blocks.

In an embodiment, the vector access unit is configured to support the type of storage shown in FIG. 6. For this purpose a circuit with structure shown in FIG. 5 can be used, wherein operand cross-bar switch 52 is constructed to pass block coordinates and plane_id's (or plane information) from a single port to a plurality of set access circuits 40, when the plane information for the plane_id for that single port 54 indicates that a plurality of sets is used for a plane and to pass pixel values between that plurality of sets and the single port and/or a group of ports that are used in conjunction with the single port to access the block.

On the data side, ports 54 may be construed to support input and/or output of a variable number of pixel values, pixel values from a plurality of set access circuits 40 being supplied to a single port 54 when the plane information for the plane_id for that single port 54 indicates that a plurality of sets is used for the indicated plane. Alternatively, separate routing control may be used for data on one hand and plane_id and block coordinates on the other hand. Thus, for example operand cross-bar switch 52 may be configured to route pixel values addressed by a single port 54 to a group of ports including the single port 54 and one or more logically adjacent ports 54, when the plane information for the plane_id for that single port 54 indicates that a plurality of sets is used for the indicated plane.

In an alternative embodiment, a mode may be supported wherein the number of pixel values that is supplied to the functional unit does not depend on the number of sets that is used. In this embodiment additional pixel value selection circuits (not shown) may be provided between set access circuits 40 and operand crossbar switch 52, to select pixel values for supply to a port from pixel values supplied by a plurality of set access circuits. In this embodiment, the pixel value selection circuits perform selection under control from plane information selected by the plane_id at the relevant port 54, for example via plane association circuit 50.

In an embodiment, memory access unit 18 controls progressive replacement of pixel values, to implement shifting a window or windows. Thus, pixel values are copied between main memory and the memory banks so that pixel values for a shifting window are accessible in the memory banks. This has the advantage that the size of the memory banks can be kept relatively small. However, alternatively large memory banks may be used that can store a complete plane. In this case use of a main memory and copying between the memory banks and the main memory is not needed.

Memory access unit 18 computes main memory addresses and memory bank addresses for pixel locations for different planes according to a copy of the plane information, and reads and writes pixel values at the computed locations. Typically, the amount of computation performed by memory access unit 18 is much smaller than that performed by the functional units, because the window is moved each time only after executing a plurality of instructions with the functional units. Accordingly, memory access unit 18 typically does not need the same massively parallel access as the functional units. In an embodiment memory access unit 18 may be implemented as a programmed processor, that is programmed to compute main memory addresses and memory bank addresses for pixel locations for different planes according to a copy of the plane information and to read and write pixel values at the computed locations. In another embodiment circuitry designed for the purpose of performing progressive replacement may be used.

Window shifting to the right in the horizontal direction involves replacement of pixel values for columns at the left of the window by pixel values for columns at the right of the window. In the case of data transfer from main memory 19 to banked memory 10 for example, memory access unit 18 overwrites memory locations in the banks that store pixel values for pixel locations in columns at the left of the window with pixel values for pixel locations in columns at the right of the window. As will be appreciated, this means that the memory locations that store the pixel value for the upper left pixel location of a currently stored window changes progressively during progressing. Window shifting to the left in the horizontal direction can be implemented in a similar way.

In an embodiment, memory access unit 18 is operated in the background on a prefetch basis while functional unit(s) 14 process instructions that apply to a current window location. For this purpose additional space may be reserved in the memory banks wherein pixel values for locations that are out of a current window are replaced by pixel values for locations that will enter the window at a next move. Interleaved access and/or multi-port access to the memory banks may be used for such background operation. This allows replacement of pixel values for locations outside the window while a complete window remains available for parallel access.

Thus, for example if an N×M window is moved progressively to the right in steps of S pixel locations at a time, pixel values for at least an (N+S)×M pixel location area are stored. Initially, the leftmost N pixel locations define the window. Pixel values for these pixel locations are kept stored in the memory banks, for parallel access. Concurrently, memory access unit 18 loads the subsequent pixel values for the next S pixel locations to the right into the memory banks. After the window is moved by S pixel locations to the right, memory locations that store pixel values for the S pixel location to the left of the window become available and memory access unit 18 loads the subsequent pixel values for the next S pixel locations to the right of the window into these locations in the memory banks and so on. Mutatis mutandis a similar approach may be used for moving the window to the left.

In addition window shifting up or down in the vertical direction may be supported, involving replacement of pixel values for columns at the left of the window by pixel values for columns at the right of the window. Similarly, if the window is moved up or down in steps of S pixel locations, memory space for N×(M+S) pixel locations may be reserved. A dynamically selectable direction of movement may even be provided for by reserving memory space for (N+S)×(M+S) pixel locations and preloading pixel values for an L shaped fringe around the window. A similar approach may also be used for output pixel values. For example, in the case of an output window that is moved right in steps of S pixel locations, memory access unit 18 writes back pixel values for S pixel locations to the left of the current window to main memory, thus creating space for S pixel locations to the right of the window after a next move.

Alternatively, memory access unit 18 may overwrite memory locations in the banks that store pixel values for pixel locations in a row at the top or bottom of the window with pixel values for pixel locations in rows at the bottom or top of the window, however, in this case use of functional units for pixel access has to be avoided or suspended while pixel values are updated.

When it is signaled that processing of a current window has finished, memory access unit 18 completes prefetching of the next window, if necessary, and updates the plane information for that window. As will be appreciated, in the case of windows with pixel values that are produced by functional unit(s) 14, memory access unit 18 may perform write back to main memory, possibly also in the background for pixel locations that are outside the current window. Memory access unit 18 may perform prefetch and/or write back for a plurality of windows, identified by different plane_id's.

In an embodiment plane information for different windows is generated dynamically, under program control. Alternatively, predefined plane information may be used that remains the same throughout program execution. In the case of dynamic definition, definition of the plane may involve writing data for a plane_id to identify a range of addresses for that plane_id into look-up memory 42, plus initialization of the coordinates of the window and the pointer to the location of the pixel value for the first pixel location of the window of the plane_id. In addition, if the size of the window can be selected, information defining the size is written for the plane_id. The information is written to the look-up memory 42 for the set access circuit of the set in which the window is stored. In the embodiment wherein different sets can be addressed from the same port 54, information is also written into plane association circuit 50 to associate the plane_id with the set in which the pixels of the plane are stored.

In the embodiment wherein pixel values of a plane can be stored distributed across a plurality of sets, definition of the plane involves storing data in each of the set access circuits 40 to identify a range of addresses for the plane_id in the set, plus initialization of the coordinates of the window and the pointer to the location of the pixel value for the first pixel location of the window of the plane_id. In this embodiment information is also written into plane association circuit 50 to associate the plane_id with the plurality of sets in which the pixels of the plane are stored. As will be appreciated, this enables the reuse of banked memory for different kinds of windows during operation.

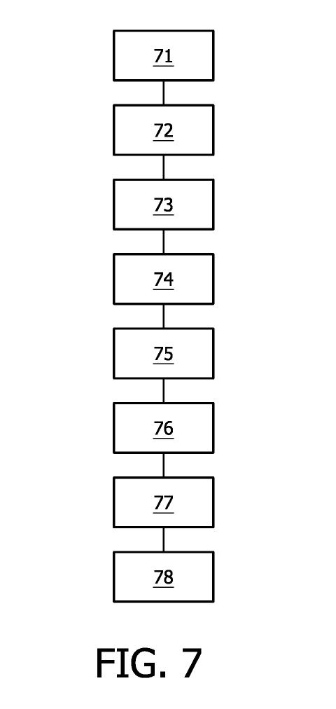

FIG. 7 shows a flow-chart of instruction processing. In a first step 71 an instruction is received and decoded. In a second step 72, a pixel location offset is computed from an operand of the instruction. In an optional third step 73, the instruction processing is delayed if there is insufficient data in the memory banks to complete the instruction (if the circuit is configured to ensure that sufficient data is available before the start of execution of the instruction this step is not needed). Also optionally if necessary, access arbitration is performed, to prevent conflicts due to simultaneous access of the same data. If there is a conflict with another access, the conflict is resolved, for example by delaying the other access or delaying execution of the instruction. In a fourth step 74, the plane_id from the instruction is used to retrieve the plane information. In a fifth step 75 the plane information is used to compute addresses in the memory banks that need to be accessed for the instruction. In a sixth step 76 the memory banks are accessed. In a seventh step 77 data for different lines of pixel locations from the memory banks is reordered. In an eight step 78 data for different positions within lines of pixel locations from the memory banks is reordered. The skilled person will appreciate that a number of the different steps may be executed in pipelined fashion for different instructions.

The reordering steps are known per se and will therefore not be described in detail. Briefly, pixel values of different lines of a block are stored at different addresses (or sets of successive addresses) in the memory banks and in different memory banks. Due the progressive replacement of data the topmost line in a block may be stored at any one of these (sets of) addresses and in any one of the banks, dependent on how far replacement has proceeded, subsequent lines being stored at subsequent addresses or banks, rolling around cyclically. Line reordering routes the pixel values from the banks that contain pixel values for pixel locations at the top of the block to the part of the data port that has to receive pixel values from the top of the block etc. Pixel reordering routes the pixel values from the banks that contains pixel value for the leftmost pixel location of the block to the part of the data port that has to receive pixel values from the left of the block etc.

At least a part of the memory banks may be shared, such as for example a part that is used for windows that can be addressed from different ports of the instruction execution circuit.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention and the circuits used therein may be implemented by means of hardware comprising several distinct elements, and/or by means of a suitably programmed processor. In the device claim enumerating elements, several of these elements may be embodied by one and the same item of hardware. The mere fact that certain measures are recited in mutually different dependent claims does not indicate that a combination of these measures cannot be used to advantage.

1. A data processing circuit, comprising:
an instruction execution circuit (14) having block data ports and block addressing outputs for outputting, for respective groups of at least one of the block data ports each, an indication of a selection of a plane and of a block of locations in the plane, defined by an executed instruction;
a plurality of memory banks (26) having address inputs and parallel memory access ports;
a plurality of translation circuits (22) coupled between the block addressing outputs and the address inputs, each for translating one of the indications of the selection of the plane and the block of locations into a selection of memory banks (26) and addresses in the selected memory banks (26); and
a routing circuit (46) coupled between the parallel memory access ports and the block data ports, for routing a plurality of data values for each block in parallel between the selected addresses in the selected memory banks (26) and the block data ports of the respective groups.

2. A data processing circuit according to claim 1, wherein the routing circuit (46) is further configured to route the data values selectably between the block data ports of any respective group and any of the memory banks (26), or from any set from a plurality of sets (20) into which the memory banks (26) are grouped, under control of the executed instruction.

3. A data processing circuit according to claim 1, wherein the indications of selections of planes are coded in a form that is capable of defining an indication dependent number of memory banks (26) that store data values for the plane, the data processing circuit comprising a further routing circuit (52) configured to route at least one of the indications to more than one of the translation circuits (22) concurrently, dependent on the number of memory banks (26) that is defined by the indication.

4. A data processing circuit according to claim 1, further comprising a plane information look-up memory (42) for storing plane information for respective planes concurrently, the plane information for each plane comprising information that indicates which of the memory banks are used to store the data values for the plane, the plane information look-up memory (42) being coupled to the translation circuits for supplying plane information selected by the executed instruction for use in translation.

5. A data processing circuit according to claim 1, wherein each of the translation circuits (22) is coupled to a respective set (20) of the memory banks (26), for controlling addressing of the memory banks (26) in the respective set (20), the data processing circuit comprising a further routing circuit (52), coupled between the block addressing outputs of the instruction execution circuit (14) and the translation circuits (22), configured to route the indications of the selections of the blocks of locations to respective ones of the translation circuits (22) under control of the plane selected for the respective block addressing output by the executed instructions.

6. A data processing circuit according to claim 5, wherein the further routing circuit (52) is configured to route the indication of the selection of the block of locations from at least a single one of the block addressing outputs to more than one of the translation circuits (22), under control of the plane selected for the single one of the block addressing outputs, in response to plane information for the plane selected by the single one of the block addressing outputs, if that plane information indicates that data values of the plane are stored distributed over the sets (20) of memory banks (26) coupled to said more than one of the translation circuits (22).

7. A data processing circuit according to claim 1, wherein the indications of the block of locations supplied at the block addressing outputs of the instruction execution circuit each comprise an indication of a size and/or shape of the block of locations, the translation circuits (22) being configured to perform said translation dependent on the indicated size and/or shape.

8. A method of executing an instruction for processing data values for a block of locations in an array of locations, the method comprising:
supplying, in the instruction, a plurality of indications, each of a selection of a plane and of a block of locations in the plane;
providing plane information for the indicated planes in parallel, the plane information for each plane comprising a selection of memory banks (26) from a banked memory circuit (10) for storage of the data values;
translating the selections of the block of locations into addressing of the selected memory banks (26) using the plane information for the indicated planes; and
routing data values between the addressed memory banks (26) and groups of each at least one data ports of an instruction processor (14) to load and/or store data values for the block of locations as part of execution of the instruction.

9. A method as claimed in claim 8, wherein said routing provides for routing data values from any of the memory banks (26) selectably to any of the groups of data ports.

10. A method as claimed in claim 8, further comprising:
supplying a definition of a number of memory banks (26) that store data values for the plane, the number of the memory banks (26) depending on the selected plane; and
translating at least one of the indications of the selections of the blocks of locations plane dependent plurality of times in parallel for respective ones of the memory banks.
